(19) United States
(12) Patent Application Publication
(10) Pub. No.: US 2014/0039998 A1
(43) Pub. Date: Feb. 6, 2014

(54) ON DEMAND KIOSK COMMERCE SYSTEM AND METHOD

(71) Applicants: Stephen H. Hancock, Wake Forest, NC (US); Norman B. Desrosiers, Oxford, NC (US); Eric Fiest, Raleigh, NC (US); John Rupert, Raleigh, NC (US)

(72) Inventors: Stephen H. Hancock, Wake Forest, NC (US); Norman B. Desrosiers, Oxford, NC (US); Eric Fiest, Raleigh, NC (US); John Rupert, Raleigh, NC (US)

(73) Assignee: FLEXTRONICS AP, LLC, Broomfield, CO (US)

(21) Appl. No.: 13/563,361

(22) Filed: Jul. 31, 2012

(51) Int. Cl. G06Q 30/06; G06Q 30/08; G06Q 30/02

(52) U.S. Cl. 705/14.23; 705/27.1

(57) ABSTRACT

Described herein are an on demand kiosk commerce system and method. The on demand kiosk commerce system and method may include a Package Delivery Kiosk (PDK), associated front end and back end package delivery management systems, portals for the consumer and the retailer, portals for the common carrier, sender, and recipient, a package inventory management system, integrated retailer access, a real and automated retailer bidding system and a kiosk for distribution.

A system for fulfilling customer orders includes an Internet accessed shopping site that permits customers to purchase a product and a product fulfillment page that allows a customer to choose among fulfillment choices including common carrier delivery and kiosk pickup. The system includes kiosks for fulfilling the kiosk pickup choice, each of the kiosks being an automatic purchase fulfillment center. The system for rapid fulfillment may include an order for immediate pickup button as part of a web interface.

### CROSS REFERENCE TO RELATED APPLICATIONS

This application is related to co-pending application entitled “ROBOTIC PACKAGE LIFTING ASSEMBLY AND METHOD” having an attorney docket number FLEX-PT046, filed concurrently herewith; co-pending application entitled “SHELVING AND KIOSK SYSTEM” having an attorney docket number FLEX-PT047, filed concurrently herewith; co-pending application entitled “AUTOMATIC PACKAGE DELIVERY AND RETRIEVAL SYSTEM” having an attorney docket number FLEX-PT048, filed concurrently herewith; and co-pending application entitled “PACKAGE DELIVERY KIOSK INCLUDING INTEGRATED ROBOTIC PACKAGE LIFTING ASSEMBLY WITH SHELVING SYSTEM” having an attorney docket number FLEX-PT050, filed concurrently herewith, the contents of which are hereby incorporated by reference herein.

### BACKGROUND

The cost associated with operating a physical store front or delivering packages via mail or other package delivery common carriers is a significant expense of doing business. The last mile of delivery of packages is many times a large percentage of the expense of delivery, especially as compared to the total distance a package travels. In some cases, individuals living in apartment type dwellings can only receive packages if they are there to physically sign for them. Considering the hours of delivery and the hours most people work, home delivery is therefore impossible. In this case the resident must go to a post office or other depot during business hours. This provides for similar difficulty.

Increasingly consumers desire immediate satisfaction of orders and purchases. In order to do so they request express shipping, (at some cost), or go to a physical store front. When going to a physical store front, the consumer may not feel as though they are getting the best prices so they may be reluctant to purchase. Consumers may return home and search on Internet shopping sites in order to obtain the best price. Also, the store may not be open or may be far away. In such case they delay acquisition of the item of interest.

Therefore, when customers shop online for an item, a method and system for more rapidly obtaining the item purchased is desirable.

### BRIEF SUMMARY

Described herein are an on demand kiosk commerce system and method. The on demand kiosk commerce system and method may include a Package Delivery Kiosk (PDK), associated front end and back end package delivery management systems, portals for the consumer and the retailer, portals for the common carrier, sender, and recipient, a package inventory management system, integrated retailer access, a real and automated retailer bidding system and a kiosk for distribution. In one embodiment, a system for rapid fulfillment of customer orders includes an order for immediate pickup button as part of a web interface, a kiosk inventory database, and a plurality of kiosks fulfilling the orders.

In one embodiment, a system for fulfilling customer orders includes an Internet accessed shopping site, the shopping site providing for a customer to purchase a product, the internet accessed shopping site hosted by a server system. The system further includes a product fulfillment page, the fulfillment page providing a user a choice for a plurality of product fulfillment choices, the plurality of product fulfillment choices including common carrier delivery, and kiosk pickup, the product fulfillment page part of internet accessed shopping site. The system further includes, a plurality of kiosks, the kiosks for fulfilling the kiosk pickup choice, each of the plurality of kiosks being an automatic purchase fulfillment center.

### BRIEF DESCRIPTION OF THE FIGURES

A more detailed understanding may be had from the following description, given by way of example in conjunction with the accompanying drawings wherein:

FIG. 1 shows one embodiment of a system for automated purchase retrieval and delivery;

FIG. 2 shows an example of a user interface for use with the system for automated purchase retrieval and delivery; and

FIGS. 3a and 3b show examples of e-commerce interfaces for selecting kiosk pickup.

### DETAILED DESCRIPTION

Certain terminology is used herein for convenience only and is not to be taken as a limitation on the embodiments of a system for on demand kiosk commerce. In the drawings, the same reference letters are employed for designating the same elements throughout the several figures.

The words “right”, “left”, “front”, and “back” designate directions in the drawings to which reference is made. The words “inwardly” and “outwardly” refer to directions toward and away from, respectively, the geometric center of the case with flexible body portion and designated parts thereof. The terminology includes the words above specifically mentioned, derivatives thereof, and words of similar import. The drawings are proportional.

Like reference numerals designate like or corresponding parts throughout the various views and with particular reference to each of the figures as delineated below.

For an on demand kiosk commerce system and method, a user has the ability to receive purchases via a number of different methods. The traditional methods of online shopping include the ability to pickup the product at a nearby store or have the item delivered via common carrier, such as UPS®, or FedEx®. In either case, there are times when the customer desires to acquire the product immediately. In the case of a common carrier, overnight shipping is usually the most rapid method of delivery. However, this may be costly. In the case of a store pickup, in many cases the store may not be open or in some areas the store may not be conveniently located. Operating a storefront requires a significant amount of overhead.

Therefore, numerous kiosks may be deployed at relatively low overall cost as compared to overnight shipping and storefront operation. These kiosks may be located in places that they may be operated 24 hours a day, seven days a week. Even in the case where a competing storefront may be open, the kiosks may be preferable to the consumer, since, the consumer may be comfortable that they are getting a good price since the product is accessed through online shopping engines, the kiosks may be deployed in a more convenient local, and lines and acquisition may be simplified, (the customer does not need to look for the item in a store.) The kiosks may be preferable to retailers due to reduced operation costs, rapid order fulfillment, and the ability to use kiosks as second tier warehouses for frequently purchased products, supplanting the need for additional warehouse space.

When the customer is shopping online, if the customer elects to utilize the kiosk system, a number of tasks are carried out. First, the system determines the location of the user. This may be via the user's Internet Protocol (IP) address, an entered zip code, information stored in a cookie or user profile, or other available information concerning the user developed through profiling or otherwise. A database storing products and their kiosk locations is retrieved. Potentially acceptable kiosk locations are presented to the user and the user may select a kiosk. After selecting a kiosk for product retrieval, the user receives a code or other activation methodology for use at the kiosk. In some cases, the user may need to establish a username and profile and may merely log into their profile at the kiosk site to retrieve the product. Alternatively, the user may enter a code, enter a code and scan an id or payment device, (such as a credit card), or combinations of these, or other identification techniques may be used.

The user then goes to the area kiosk that stores the user's purchase. Kiosks may be distributed as needed for convenient purchase retrieval. Optionally, once a user registers for purchase retrieval, the user may specify which of area kiosks the user wishes to retrieve the purchases at. The kiosk system may build a profile for a plurality of users that typically purchase and retrieve packages from kiosks and kiosks may be selected as preferred kiosks by the user.

At the kiosk, a touch screen interface greets the customer, and the customer provides the authentication information including in many embodiments a personal pin code and the web code or other code identifying the purchase. The customer may login to their profile or account and select the purchase they wish to retrieve. The kiosk confirms that the purchase is available for the system using the system software installed on the kiosk. The kiosk cross-references the codes provided to ensure authentication. The kiosk additionally may have cameras to record images of the user who accesses the kiosk. Additionally, the kiosk may have automatic finger print storage and may image fingerprints as the user touches the screen of the interface. Alternatively, other types of interfaces may be used, including those utilizing keyboards, rollerballs, or other interfaces.

Optionally, the customer then provides a signature to receive the purchase. If the customer ceases to provide input or signature then the system may be configured to time out and return to the initial screen. Optionally, the security camera may be configured to detect when a user leaves the interface and automatically timeout upon such an occurrence. Optionally, the security camera may simply take one or a number of pictures during the interaction.

After the entire required authentication has been achieved the kiosk system may retrieve the purchase and deliver it to the outlet system for the user to obtain through a slot or other deliver area.

The system further includes an operation procedure for an operator, (such as a distributor). The system may be configured to track which items in the kiosk have been resident for an extended period of time. The kiosk may automatically sort these items into a predefined area in the kiosk and their “dead” status reported. These are items that customers are not frequently ordering for purchase on an On Demand basis.

The machine may then be accessed by the operator. During preferably a non-busy time, the operator may enter a special code into the touch screen interface to enable access to the items and system. The kiosk may then automatically unlock itself or the operator may unlock another manual lock. A maintenance screen is displayed and the system becomes inactive. The operator may then retrieve dead items, either from a dedicated area or according to information provided by the interface. New items for purchase may be then inserted by size and bar code identifying information. The operator then confirms the completion of item exchange using the touch screen and in some cases locking the kiosk. The kiosk confirms that a successful item exchange and lock has been made and then begins to process each item.

The kiosk system then reads the bar code, (such as a SKU or other information that may be stored concerning the item), from each item and stores the identifying information and location of the item for purchase. In some cases the kiosk may then proceed to relocate items. The kiosk can send confirmation information to a central server indicating that an item is available for coordinated pickup at the kiosk. The central server may then contact related systems providing electronic notification of the availability of a product.

The kiosk system provides 24 hour, seven day a week purchase pickup in a secure environment. It eliminates the delivery cost to the end customer and eliminates storefront costs for retailers. The system confirms pickup and captures optionally, signature, picture, or other identifying information.

As shown, a kiosk and related systems may be implemented in hardware and software. The kiosk 100 may implement various modules. The kiosk 100 may implement multiple user interfaces, for example, a customer graphics user interface (GUI) 111, a United States Postal Service (USPS) driver interface 112, an administrative interface 113 and an out of order interface. The customer GUI 111 is a graphical user interface and provides for the user to interact with the kiosk 100. The user may be able to determine information about the package including, for example, the sender, the size, the time it has been waiting for pickup, and any other potential information concerning the package. The user may also be able to retrieve information concerning the kiosk 100, including location, access hours, accessibility of the handicap, and any other information available about the kiosk.

The USPS Driver Interface 112 may provide the user access to the package for retrieval. This interface 112 provides for the entering of the identification information for the package and the user request for packages or other information. Although this is labeled USPS, it may be for any common carrier.

Administration driver 113 provides for access to the kiosk 100 for cleaning and testing functions, loading and unloading, and reconfiguration features. The kiosk 100 includes a robotic package retrieving apparatus and a number of package slots. As described herein, an operator may come to change out dead packages and add new packages. Further, the package slots may be periodically reconfigured and therefore the operator may provide information to the system concerning the new location of slots. The operator may then initiate an alignment procedure where the robotic package retrieving system, also know as a Robotic Package Lifting Assembly (RPLA), attempts to align with the newly entered slots. The operator may then observe the RPLA and register if any alignments are off.

Out of order interface 114 provides for an out of order signal to users and operators. This interface 114 does not provide for access for package retrieval, however, it may provide for diagnosis information and access for the operator.

Customer GUI 111 and USPS Driver 112 communicate with data transport layer 115. Customer GUI 111 provides for access via the Internet. Data transport layer 115 may communicate with reporting server 120. Reporting server 120 may report the pickup of a package by either directing digital messaging or mail messaging. Digital messaging may be accomplished through notification agent 122 or email server 121. Notification agent 122 or email server 121 may send emails, SMS messages or any other type of electronic message to the package sender, recipient and the operator/common carrier as required by protocol and preferences.

Kiosk 100 may include core queues 125 and other data queues 126. These queues may track the location, resident time, pickup information, and other information concerning the resident packages and overall performance of the system.

The user interfaces of the kiosk may be controlled by a number of touch screen modules. These modules may include: virtual vending control board 130 which provides control of the package selection process; virtual card reader 131 which provides for scanning of credit cards and other cards; virtual bar code reader 132 which provides for scanning of bar codes associated with package pickups; and virtual pin pad 133 which provides for a virtual pin pad for entering a pin. These provide for virtualizations that allow a user to navigate the kiosk.

A number of hardware plug-ins are also included to assist in the control of the system, including, card reader plug-in 135 for reading cards, security camera plug-in 136 for operating and interfacing with the security camera, barcode reader 137 for use with the RPLA, label printer 138 for print labels for dropped-off packages, directional pin pad plug-in 139 for controlling the operation and display of the pin pad, call modem 140, vending control board 141 for controlling the RPLA and barcode reader external 142 for providing external barcode reading functions.

The kiosk system 100 may also include a management console 150 for the client and a remote desktop server 151. The management console 150a provides for control through management console client 150b. A client may use a remote desktop client 151b connected to a remote desktop server 151a to access the kiosk 100. These may be accessible through a Web browser, for example, an Internet Explorer interface and may include software for generating retrieval keys to the kiosk using module 152.

Through data transport 115 various systems may report to SQL server 155 which serves as the primary repository of information for the kiosk and related systems. The backend servers 160 and 161 may provide for Web access to users and operators through the Web code backend application programming interface 162. Further information about the performance and history of the kiosk may be stored and reported to SQL server 155 and accessible through IIS 165 and system administration 166. Reports concerning the performance may be produced through the reports module 167, including reports on sales information 168, marketing information 169, inventory information 170, maintenance information 171, and user information 172.

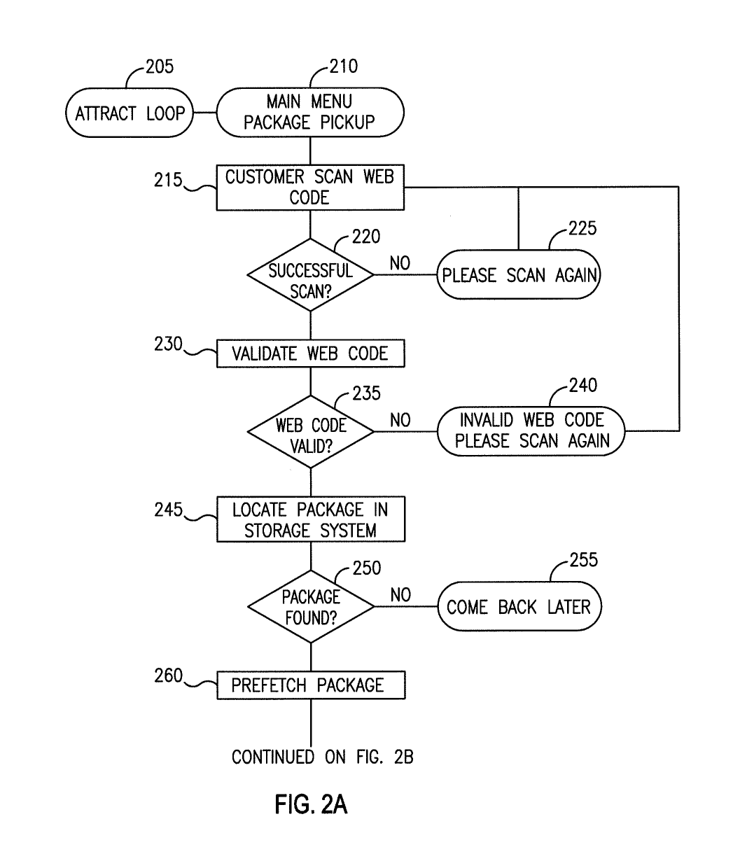

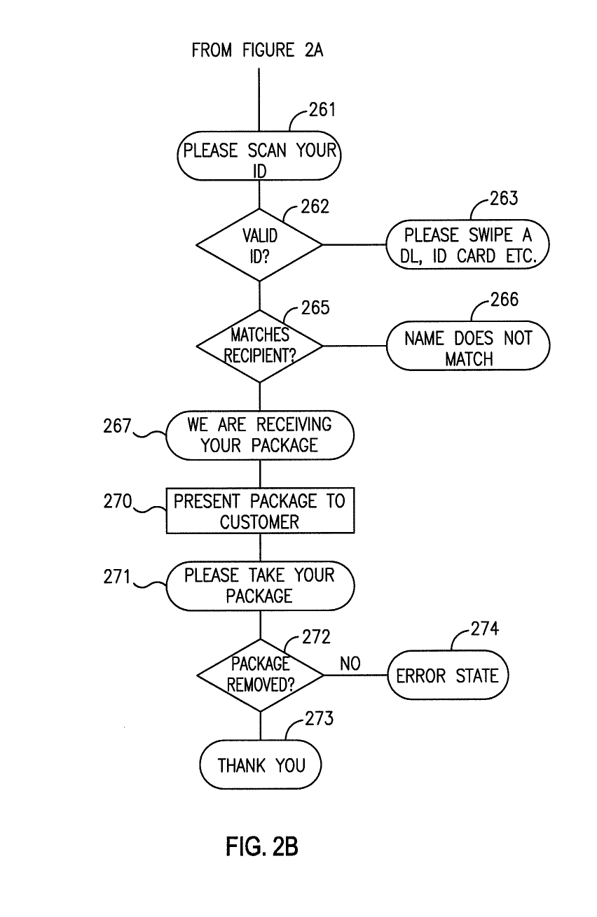

FIG. 2 shows an example of a user interface flowchart for the kiosk. Starting at attract loop 205, the system displays a loop that will attract users to the screen and display a message such as “touch to begin.” When the user touches the screen, the flow proceeds to the main menu screen (210). The user may scan the web code on their notice (215). Alternatively, the system may allow for the user to enter a code. If the scan is determined unsuccessful (220, no), the user will be prompted to scan again (225). If the scan is successful (220, yes), the web code will be validated (230). If the code is determined to be invalid (235, no), the user is notified of an invalid code (240). The user may then re-enter or scan the web code again (215). If the code is valid (235, yes), the location of the package in the system is determined (245). If the package is not found (250, no), the user is notified to come back later (255) or otherwise informed to contact support.

If the package is found (250, yes), the package is prefetched in that the RPLA may align with the package location (260). A request for the user to scan their id is requested (261). This may be a license or other preapproved identification. The validity of the id is determined (262). If the id is not valid (262, no), the system will request a rescan (263). If the id is valid (262, yes), it is determined whether the recipient name matches the id provided (265). If the name does not match (265, no), the user will be prompted that the name does not match (266). Some systems may permissively allow non-matching users access. In the alternative, no access may be provided. In the alternative, a pin may be required as well. If the name does match (265, yes), the user is informed of package retrieval (267). The user is requested to take the package (270). It is determined whether the user took the package (271). If the user did take the package (272, yes), the system terminates in a thank you (273). If the user fails to take the package (272, no), the system provides an error message (274).

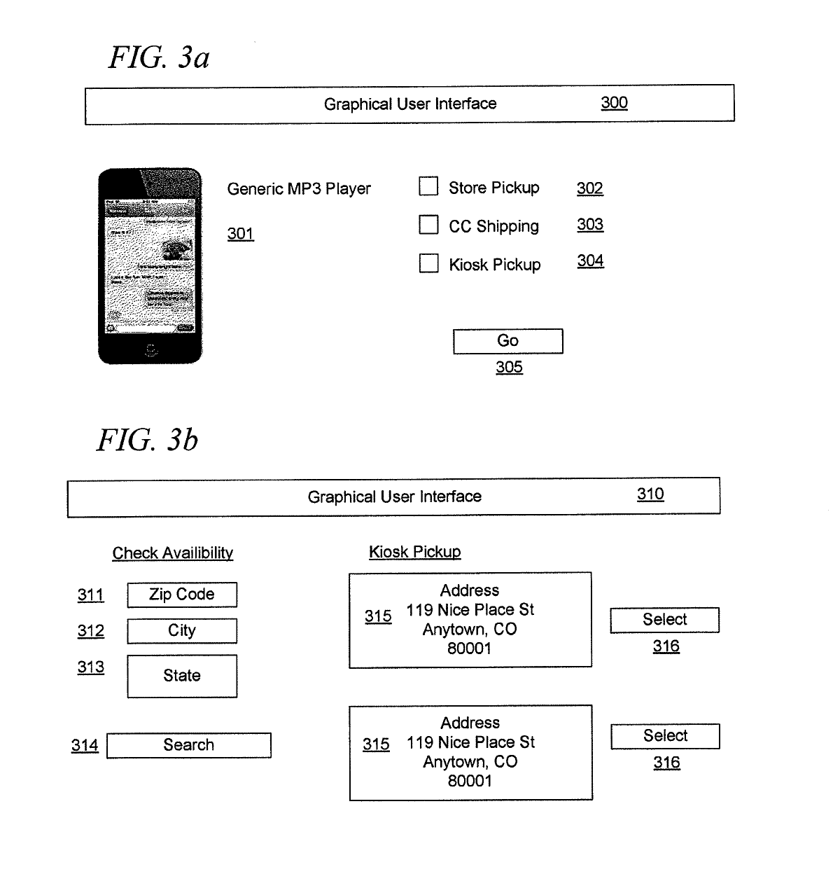

FIGS. 3a and 3b show examples of e-commerce interfaces for selecting kiosk pickup. In a webpage graphical user interface (GUI) 300, after the user has selected a product for purchase, such as a generic MP3 player 301, the user may choose a method to receive the generic MP3 player 301. The offered methods may include store pickup 302, common carrier shipping 303, and kiosk pickup 304. After the user has selected the preferred choice, the user actuates the go button 305. Numerous other methods of structuring the GUI will occur to those skilled in the art in light of this description.

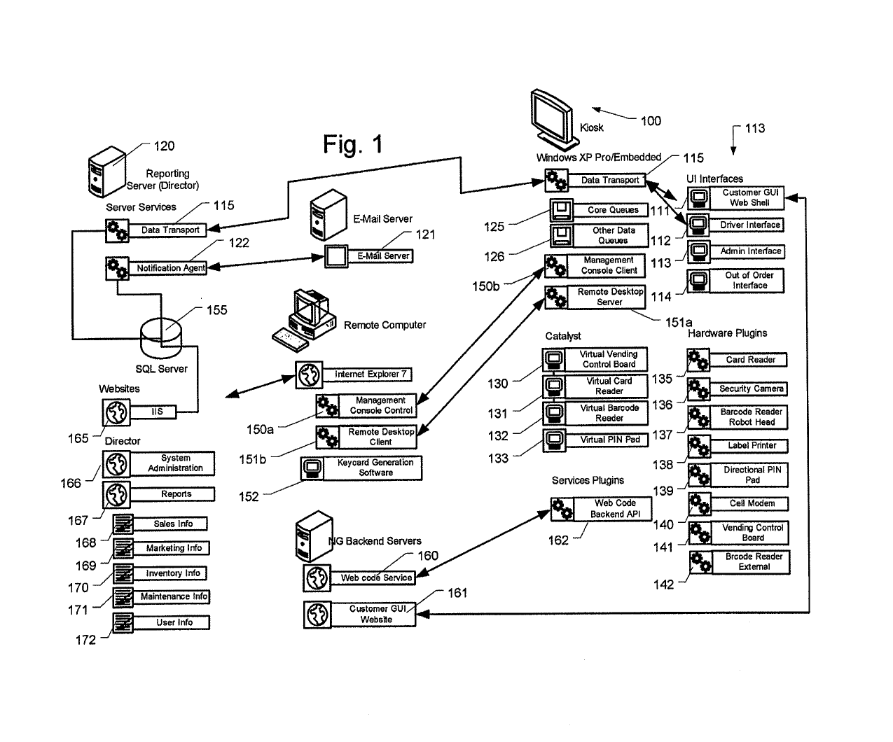

In FIG. 3b, GUI 310 allows the user to enter their location by providing a zip code 311, or city 312 and state 313 and actuating search 314. Various other options may be available such as radius of search and least cost provider preferences, (in some cases kiosk pickup may be charged to the user). As noted above, other methodologies of determining the user's location may be utilized as well. The page then provides locations of kiosks for pickup including their address 315 and a select button 316 for selecting a particular kiosk. When user enters their location, the system may query the SQL server 155 (shown in FIG. 1), to determine the availability of the item to be purchased. The system may query a database provided by a single kiosk management entity, or may query several different kiosk management databases. The location of the user is cross-referenced against know locations of the item and displayed for the user to select.

Alternatively, if multiple kiosk carriers are available, they may bid on the opportunity to provide the actual product to the consumer. In this case the e-commerce site merely provides the conduit. In this case, an automated system from each kiosk and product provider sends a bid to the e-commerce site that is effectuating the sale. The e-commerce site may then select the lowest bid within a geographical area or accept all bids under a certain threshold in a geographic area. In some cases the e-commerce site may allow for pickup at a certain kiosk. However, it may also tack on an additional fee to retain its profit margin, notifying the user of the additional fee.

In some embodiments, the kiosk may be additionally configured for receiving returns. In this case, the user indicates a return using the touch screen interface information concerning the package. The user may then insert the package and the RPLA retrieves the package and places the package in a slot reserved for returned items. The user may not be credited until the return is confirmed by an operator at a later date. The user may be notified that credit may not occur until the later date. In most embodiments, cash is not returned to the user since confirmation of return is required and it is a security risk for machines to have significant cash on hand. The user may then provide credit information or other account information for credit, (such as Paypal®).

During regular drop-off and pickup of items for purchase, the operator retrieves the package and carries out the return to be verified. Upon deposit, the kiosk may generate an expected return confirmation and credit date based on kiosk pickup times and standard delivery models. This may provide the user additional flexibility over traditional models, since the user may access the kiosk at any time of the day.

In some embodiments, the kiosk may be configured with its own WiFi signal or website that the user may log into and purchase items from a specific kiosk. By connecting to the Kiosk's WiFi signal or webpage, the user may bypass traditional online shopping and purchase directly from a particular kiosk with their smart phone, laptop, or other computing device. This feature would be usually utilized when the user is already proximate to a particular kiosk. Alternatively, the GUI of the kiosk may provide for product purchase and navigation.

In some embodiments, the kiosk system tracks the purchase of frequently purchased products in an area and provides statistics on recurrent product purchases so kiosks may be stocked accordingly to meet those projected purchases. The system may correlate recent user purchases. Statistics concerning the products, including type and brand and cost, purchased in particular locations through kiosk systems may be tracked and recorded such that predictions about future products may be made and kiosks may be stocked similarly.

In general, a system for fulfilling customer orders includes an Internet accessed shopping site that allows a customer to purchase a product. The Internet accessed shopping site may be hosted by a server system. The system further includes a product fulfillment page that provides a user a choice from a plurality of product fulfillment choices. The plurality of product fulfillment choices may include common carrier delivery, and kiosk pickup. The product fulfillment page may be part of the Internet accessed shopping site. The system further includes a plurality of kiosks that fulfill the kiosk pickup choice. Each of the plurality of kiosks being an automatic purchase fulfillment center. Optionally, the plurality of product fulfillment choices also includes a retail store.

In one configuration, the product fulfillment page provides the user an indication of a first location of a first kiosk of the plurality of kiosks where the product is available. In another configuration, the first kiosk determined by the product fulfillment page is based on a geographic indication of the user. Optionally, the geographical indication is a second location of the user. In one alternative, the product fulfillment page connects to a first database storing an inventory of the product. The inventory of the product may be associated with the plurality of kiosks such that for the first kiosk of the plurality of kiosks, a first indication is stored in the database indicating that the product is available at the first kiosk. In another alternative, for a second kiosk of the plurality kiosks, a second indication is stored in the database indicating that the product is not available at the second kiosk and for a third kiosk of the plurality kiosks, a third indication is stored in the database indicating that the product is available at the third kiosk. Optionally, the product fulfillment page provides the user an indication of a second location for the third kiosk of the plurality of kiosks where the product is available. The third kiosk determined by the product fulfillment page based on the geographic indication of the user. The product fulfillment page may provide the user a code to access the product at the first kiosk.

Optionally, the Internet accessed shopping site is provided by a first entity and the kiosk pickup and plurality of kiosks is provided by a second entity. In one alternative, the second entity offers the kiosk pickup at a first kiosk pickup price and the first entity provides the kiosk pickup at a second kiosk pickup price, where the second kiosk pickup price being a rebate amount plus the first kiosk pickup price. Optionally, the rebate amount is negative and is a cost savings to the customer. In another alternative, the Internet accessed shopping site is provided by a first entity and the kiosk pickup and plurality of kiosks is provided by a plurality of second entities and the plurality of second entities bid on a opportunity to deliver the product, wherein the bidding occurs by a computing system without human intervention matches a first kiosk of the plurality of kiosks based on a cost and a proximity to the customer. The selected entity of the plurality of second entities is the entity that provides the lowest cost.

In one embodiment, a method for providing an on demand product to a consumer includes presenting a user an Internet accessed shopping site, and a plurality of product fulfillment choices. The shopping site allowing a customer to purchase a product. The internet accessed shopping site being hosted by a server system. The method further includes receiving a choice of one of the plurality of product fulfillment choices from the user. The plurality of product fulfillment choices including common carrier delivery, and kiosk pickup. The product fulfillment page may be a part of the Internet accessed shopping site. The method further includes providing a product at a first kiosk of a plurality of kiosks, where the kiosks are for fulfilling the kiosk pickup. Each of the plurality of kiosks being an automatic purchase fulfillment center. In one configuration, the plurality of product fulfillment choices also includes a retail store.

Optionally, the method further includes providing a pickup code to the user after purchasing at the Internet accessed shopping site is complete and verifying the pickup code at the first kiosk prior to providing the product.

In another configuration, the product fulfillment page provides the user an indication of a first location of a first kiosk of the plurality of kiosks where the product is available. Optionally, the first kiosk determined by the product fulfillment page based on a geographic indication of the user.

Alternatively, the product fulfillment page connects to a first database storing an inventory of the product. The inventory of the product associated with the plurality of kiosks such that for the first kiosk of the plurality kiosks, a first indication is stored in the database, where the first indication indicates that the product is available at the first kiosk. Optionally, for a second kiosk of the plurality kiosks, a second indication is stored in the database, where the second indication indicates that the product is not available at the second kiosk and for a third kiosk of the plurality kiosks, a third indication is stored in the database, where the third indication indicates that the product is available at the third kiosk.

While specific embodiments have been described in detail in the foregoing detailed description and illustrated in the accompanying drawings, it will be appreciated by those skilled in the art that various modifications and alternatives to those details could be developed in light of the overall teachings of the disclosure and the broad inventive concepts thereof. It is understood, therefore, that the scope of this disclosure is not limited to the particular examples and implementations disclosed herein, but is intended to cover modifications within the spirit and scope thereof as defined by the appended claims and any and all equivalents thereof. Note that, although particular embodiments are shown, features of each may be interchanged between embodiments.

What is claimed is:

1. A system for fulfilling customer orders, comprising:
an Internet accessed shopping site, the shopping site permitting a customer to purchase a product, the Internet accessed shopping site hosted by a server system;
a product fulfillment page, the fulfillment page providing a customer a choice among a plurality of product fulfillment choices, the plurality of product fulfillment choices including common carrier delivery and kiosk pickup, the product fulfillment page part of the Internet accessed shopping site; and
a plurality of kiosks, the kiosks for fulfilling the kiosk pickup choice, each of the plurality of kiosks being an automatic package fulfillment center.

2. The system of claim 1, wherein the plurality of product fulfillment choices also include a retail store.

3. The system of claim 1, wherein the product fulfillment page provides the customer an indication of a first location of a first kiosk from the plurality of kiosks where the product is available.

4. The system of claim 3, wherein the first kiosk is determined by the product fulfillment page based on a geographic indication of the customer.

5. The system of claim 4, wherein the geographic indication is a second location of the customer.

6. The system of 4, wherein the product fulfillment page connects to a first database storing an inventory of the product, the inventory of the product associated with the plurality of kiosks such that for the first kiosk of the plurality kiosks, a first indication is stored in the database, the first indication indicating that the product is available at the first kiosk.

7. The system of claim 6, wherein for a second kiosk of the plurality kiosks, a second indication is stored in the database, the second indication indicating that the product is not available at the second kiosk and for a third kiosk of the plurality kiosks, a third indication is stored in the database, the third indication indicating that the product is available at the third kiosk.

8. The system of claim 7, wherein the product fulfillment page provides the customer an indication of a second location of the third kiosk of the plurality of kiosks where the product is available, the third kiosk determined by the product fulfillment page based on the geographic indication of the customer.

9. The system of claim 1, wherein the product fulfillment page provides the customer a code to access the product at the first kiosk.

10. The system of claim 1, wherein the Internet accessed shopping site is provided by a first entity and the kiosk pickup and plurality of kiosks is provided by a second entity.

11. The system of claim 10, wherein the second entity offers the kiosk pickup at a first kiosk pickup price and the first entity and the first entity provides the kiosk pickup at a second kiosk pickup price, the second kiosk pickup price being a rebate amount plus the first kiosk pickup price.

12. The system of claim 11, wherein the rebate amount is negative and is a cost savings to the customer.

13. The system of claim 1, wherein the Internet accessed shopping site is provided by a first entity and the kiosk pickup and plurality of kiosks is provided by a plurality of second entities and the plurality of second entities bid on a opportunity to deliver the product, wherein the bidding occurs by a computing system without human intervention matches a first kiosk of the plurality of kiosks based on a cost and a proximity to the customer, the selected entity of the plurality of second entities being the entity that provides at lowest cost.

14. A method for providing an on demand product to a user, the method comprising:
presenting the user of an Internet accessed shopping site, a plurality of product fulfillment choices, the shopping site allowing the user to purchase a product, the Internet accessed shopping site hosted by a server system;
receiving a choice of one of the plurality of product fulfillment choices from the user, the plurality of product fulfillment choices including common carrier delivery, and kiosk pickup, the product fulfillment page part of the Internet accessed shopping site; and
providing a product at a first kiosk of a plurality of kiosks, the kiosks for fulfilling the kiosk pickup, each of the plurality of kiosks being an automatic purchase fulfillment center.

15. The method of claim 15, further comprising:
providing a pickup code to the user after purchasing at the Internet accessed shopping site is complete; and
verifying the pickup code at the first kiosk prior to providing the product.

16. The method of claim 14, wherein the plurality of product fulfillment choices also include a retail store.

17. The method of claim 14, wherein the product fulfillment page provides the user an indication of a first location of a first kiosk of the plurality of kiosks where the product is available.

18. The method of claim 17, wherein the first kiosk determined by the product fulfillment page based on a geographic indication of the user.

19. The method of claim 18, wherein the product fulfillment page connects to a first database storing an inventory of the product, the inventory of the product associated with the plurality of kiosks, such that for the first kiosk of the plurality kiosks, a first indication is stored in the database, the first indication indicating that the product is available at the first kiosk.

20. The method of claim 19, wherein for a second kiosk of the plurality kiosks, a second indication is stored in the database, the second indication indicating that the product is not available at the second kiosk and for a third kiosk of the plurality kiosks, a third indication is stored in the database, the third indication indicating that the product is available at the third kiosk.
